(19) United States
(12) Patent Application Publication
(10) Pub. No.: US 2017/0060505 A1
(43) Pub. Date: Mar. 2, 2017

(54) COMPUTER-READABLE RECORDING MEDIUM, INFORMATION PROCESSING DEVICE, AND INFORMATION PROCESSING SYSTEM

(71) Applicant: Daisuke TAMASHIMA, Kanagawa (JP)

(72) Inventor: Daisuke TAMASHIMA, Kanagawa (JP)

(73) Assignee: RICOH COMPANY, LTD., Tokyo (JP)

(21) Appl. No.: 15/249,839

(22) Filed: Aug. 29, 2016

(30) Foreign Application Priority Data
Sep. 1, 2015 (JP) 2015-172216
Aug. 8, 2016 (JP) 2016-155860

(51) Int. Cl. G06F 3/12; H04N 1/00

(52) U.S. Cl. CPC G06F 3/1258; H04N 1/00411; H04N 1/00413; G06F 3/1203; G06F 3/1211; G06F 3/1276; H04N 2201/0082

(57) ABSTRACT

An information processing device configured to transmit a print instruction to an imago processing device through a network, the information processing device includes: a storage control unit configured to store, in a storage unit, the number of changes made on a print setting option through the information processing device; a determining unit configured to determine a setting option to be displayed based on the number of changes, and determine a related option of the determined setting option to be a related option to be displayed; and a display control unit configured to display the determined setting option and the determined related option on a display unit.

### CROSS-REFERENCE TO RELATED APPLICATIONS

The present application claims priority under 35 U.S.C., §1.19 to Japanese Patent Application No. 20.15-172216 filed Sep. 1, 2015 and Japanese Patent Application No. 2016-155860 filed Aug. 8, 2016. The contents of which are incorporated herein by reference, in their entirety.

### BACKGROUND OF THE INVENTION

1. Field of the Invention

The present invention relates to a computer-readable recording medium, an information processing device, and an information processing system.

2. Description of the Related Art

When printing, a printer driver provides a user with a print setting screen as a print setting interface. The user performs print setting through the provided print, setting screen. The printer driver generates print data based on the print setting performed through the print setting screen. There are a large number of print setting options that can be set through the print setting screen.

Thus, the printer driver displays the print setting screen in a divided manner on a plurality of pages. Having detected a button operation, the printer driver changes the print setting options being displayed, or displays, for example, a dialogue box for performing detailed print setting. The printer driver also stores therein a plurality of print settings having high frequencies of use in association with a predetermined button. Upon an operation on the predetermined button, the printer driver displays a list of the associated print settings. A conventional technique is described in Japanese Unexamined Patent Application Publication No. 2011-186626, for example.

However, the conventional printer driver is configured to display a typical setting option having a high frequency of use and set in advance by a manufacturer. This display configuration displays a setting option highly likely to be used by a large number of users, in other words, a typical setting option for everyone. Thus, the conventional printer driver has a problem in that it is unlikely to display the setting options to be actually used by a user that performs printing. When the displayed setting is different from a desired setting, the user needs to perform an operation to change the settings. Accordingly, the conventional printer driver potentially causes degradation of the operability and usability of, for example, a printing device to which the conventional printer driver is applied.

In consideration of the problem described above, there is a need to provide a computer-readable recording medium having a print control program, an information processing device, and an information processing system that are capable of improving the operability and usability of a device.

### SUMMARY OF THE INVENTION

Exemplary embodiments of the present invention, there is provided a non-transitory computer-readable recording medium that contains a print control program executed by a computer configured to transmit a print instruction to an image processing device through a network, the print control program being configured to cause the computer to function as: a storage control unit configured to store, in a storage unit, the number of changes made on a print setting option through the print control program; a determining unit configured to determine a setting option to be displayed based on the number of changes and determine a related option of the determined setting option to be a related option to be displayed; and a display control unit, configured to display the determined setting option and the determined related option on a display unit.

Exemplary embodiments of the present, invention also provide an information processing device configured to transmit a print instruction to an image processing device through a network, the information processing device comprising: a storage control unit configured to store, in a storage unit, the number of changes made on a print, setting option through the information processing device; a determining unit configured to determine a setting option to be displayed based on the number of changes, and determine a related option of the determined setting option to be a related option to be displayed; and a display control unit configured to display the determined setting option and the determined related option on a display unit.

Exemplary embodiments of the present invention also provide an information processing system comprising: an image processing device configured to perform image processing; and an information processing device configured to transmit a print instruction to the image processing device through a network, the information processing device including: a storage control unit configured to store, in a storage unit, the number of changes made on a print setting option through the information processing device, a determining unit configured to determine a setting option to be displayed based on the number of changes, and determine a related option of the determined setting option to be a related option to be displayed, and a display control unit configured to display the determined setting option and the determined related option on a display unit.

### BRIEF DESCRIPTION OF THE DRAWINGS

FIG. 1 is a system configuration diagram of a printing system according to a first embodiment of the present invention;

FIG. 2 is a block diagram of a personal computer provided to the printing system according to the first embodiment;

FIG. 3 is a functional block diagram of a CPU of the personal computer;

FIG. 4 is a sequence diagram of printing in the printing system according to the first embodiment;

FIG. 5 is a sequence diagram of print setting in the printing system, according to the first embodiment;

FIG. 6 is a diagram illustrating exemplary use frequency information;

FIG. 7 is a diagram illustrating exemplary related options;

FIG. 8 is a diagram illustrating exemplary form information;

FIG. 9 is a diagram illustrating exemplary setting options and related options;

FIG. 10 is a diagram illustrating an exemplary print, setting screen displaying a list of setting options having high frequencies of use by a user;

FIG. 11 is a diagram illustrating an example of setting options, related options, and setting options in an exclusive relation in a printing system according to a second embodiment of the present invention;

FIG. 12 is a diagram illustrating an exemplary screen for informing the user of the presence of the setting options in an exclusive relation in the printing system according to the second embodiment;

FIG. 13 is a diagram illustrating an exemplary print setting screen displaying the settings of functions categorized in an identical category in close proximity to each other in a printing system according to a third embodiment of the present invention;

FIG. 14 is a diagram illustrating a list of functions categorized in an identical category;

FIG. 15 is a diagram illustrating exemplary categorizing information indicating the category of each setting option;

FIG. 16 is a flowchart of the process of an operation performed by a determining unit to determine a display order of setting options based on their frequencies of use and categories; and

FIG. 17 is an exemplary print, setting screen not. displaying setting options affected by exclusion in a printing system according to a fourth embodiment of the present invention.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Embodiments of the present invention will be described below in detail with reference to the accompanying drawings.

### First Embodiment

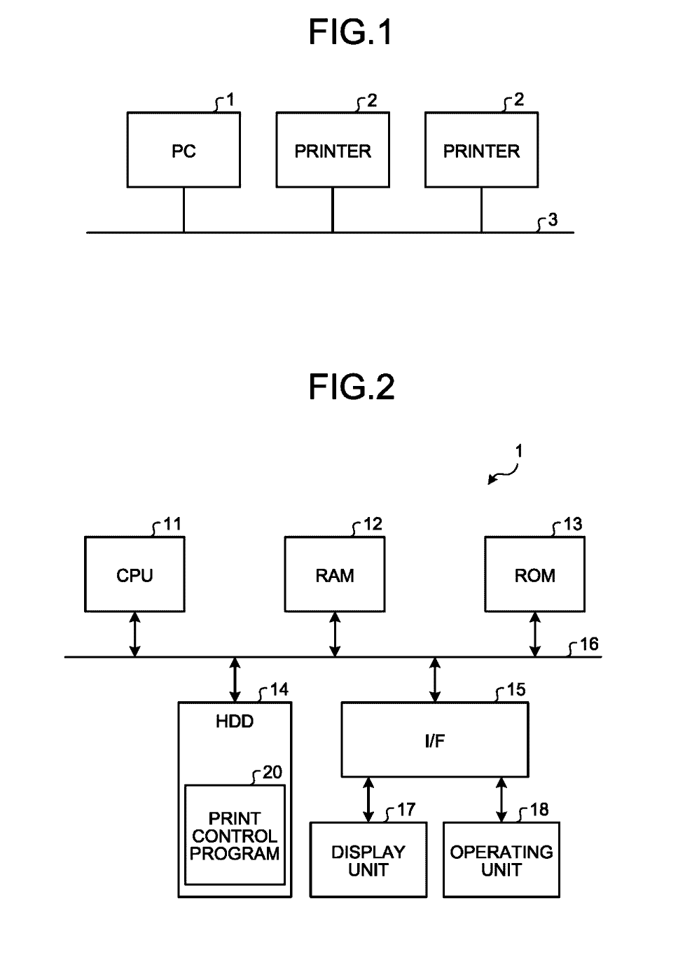

FIG. 1 is a system configuration diagram of a printing system according to a first embodiment of the present invention. As illustrated in FIG. 1, the printing system is formed by mutually connecting one (or a plurality of) personal computer (PC) 1 and a plurality of (or one) printers 2 through a predetermined network 3 such as a local area network (IAN).

FIG. 2 is a block diagram of the PC 1. The PC 1 is formed by mutually connecting a central processing unit (CPU) 11, a random access memory (RAM) 12, a read only memory (ROM) 13, a hard disk drive (HDD) 14, and an interface (I/F) 15 through a bus line 16. The interface 15 is connected with, for example, a display unit 17 such as a liquid crystal display (LCD), and an operating unit 18 such as a keyboard or a mouse device.

The RAM 12 is a volatile storage medium capable of reading and writing information at high speed, and is used as a work area by the CPU 11 to process information. The ROM 13 is a non-volatile storage medium dedicated to reading, and stores therein a computer program such as firmware. The ROM 13 stores therein a control program such as an operating system (OS). The HDD 14 stores therein various application programs including a print control program 20. The CPU 11 controls the entire operation of the PC 1 based on the OS stored in the ROM 13. The CPU 11 performs print control of the printers 2 through the network 3 based on the print control program 20 stored in the HDD 14.

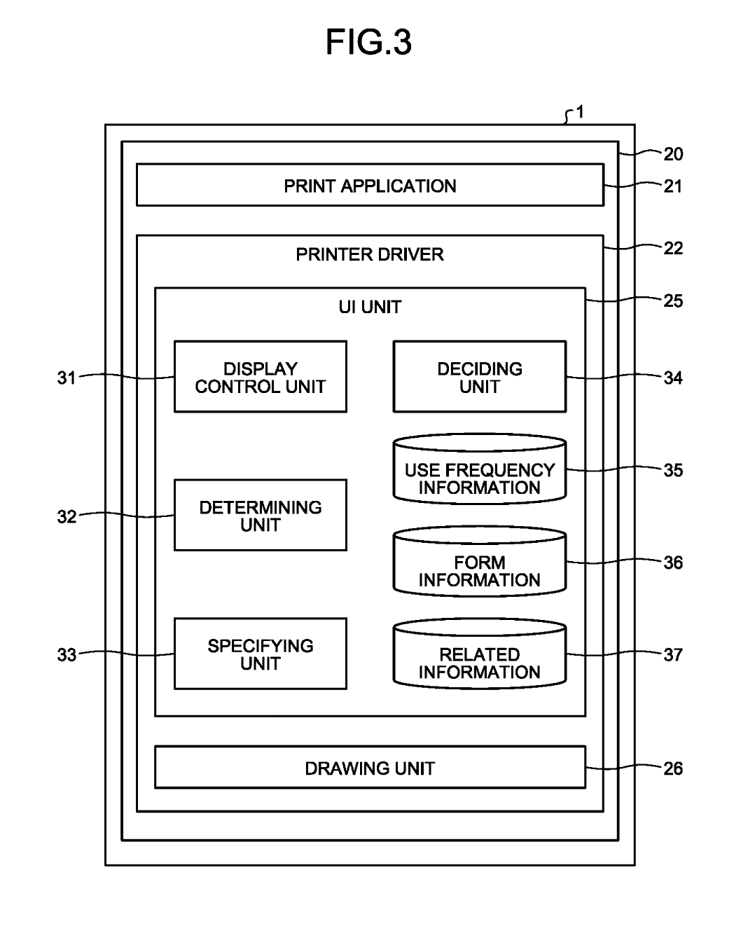

FIG. 3 is a functional block diagram of functions achieved by the CPU 11 executing the print control program 20 stored in the HDD 14 of the PC 1. As illustrated in FIG. 3, the print control program 20 includes a print application 21 and a printer driver 22 for actually performing printing. The printer driver 22 includes an UI unit 25 and a drawing unit 26.

Although the print application 21 and the printer driver 22 are achieved by the CPU 11 through software in this example, part or all thereof may be achieved by hardware such as an integrated circuit (IC). The print control program may be recorded in and provided as a file in an installable or executable format in a computer-readable recording medium such as a CD-ROM, a flexible disk (FD), a CD-R, a DVD, a Blu-ray Disc (registered trademark), or a semiconductor memory. The print control program may be provided and installed through a network such as the Internet. The print control program may be incorporated in advance and provided in, for example, a ROM in a device.

The drawing unit 26, upon receiving a print request from the print application unit 21, reflects the print settings, and converts them into print data. The UI unit 25 provides a user with an interface that allows change of print setting and receives any change of print setting.

The UI unit 25 includes a display control unit 31, a determining unit 32, a specifying unit 33, and a deciding unit 34. The UI unit 25 displays a print setting screen including a list of setting options and related options corresponding to each user's frequency of use based on use frequency information 35, form information 36, and related information 37 stored in, for example, the RAM 12. The UI unit 25 requests print setting display from the display control unit 31. The UI unit 25 also requests print setting change determination from the deciding unit 34.

Having received the print setting display request from the UI unit 25, the display control unit 31 acquires, from the determining unit 32, information for displaying the settings more frequently used (larger number of changes) by the user, and displays the print setting screen on the display unit 17.

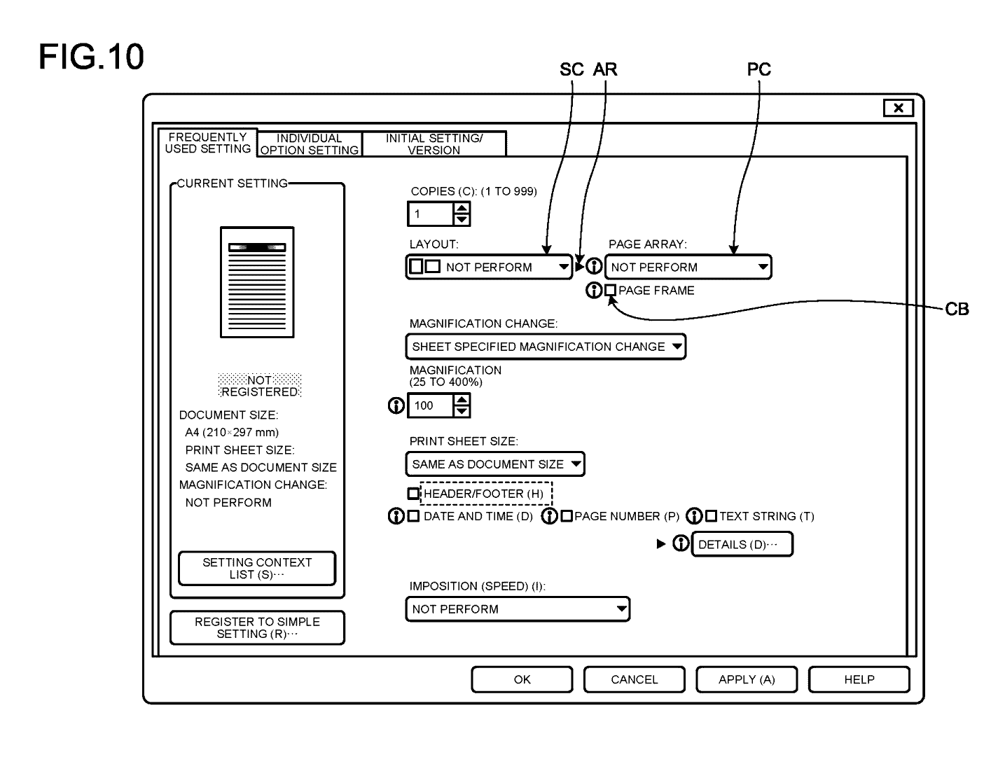

The determining unit 32 determines “functions more frequently used by the user” based on the use frequency information 35. The “functions” are “setting options” of, for example, “copies”, “layout”, “magnification change”, or “print, sheet size” to be described later with reference to, for example, FIG. 10. The use frequency information 35 is information indicating the number of times that printing is performed with the settings changed from the default settings. The use frequency information 35 is generated every time printing is performed, by incrementing the numbers indicating the frequency of use of functions with the settings changed from the default settings. The use frequency information 35 is generated for each function.

As described later, the determining unit 32 acquires the related information 37 indicating related options of determined setting options from the specifying unit 33, and determines options to be displayed on the print setting screen based on the use frequency information 35, the form information 36, and the related information 37. The form information 36 is information indicating the width and height of control objects of each function. The form information 36 is information indicating the width and height of the display of a setting option and the related options of the setting option in combination. The specifying unit 33 specifies related options of each setting option based on the related information 37.

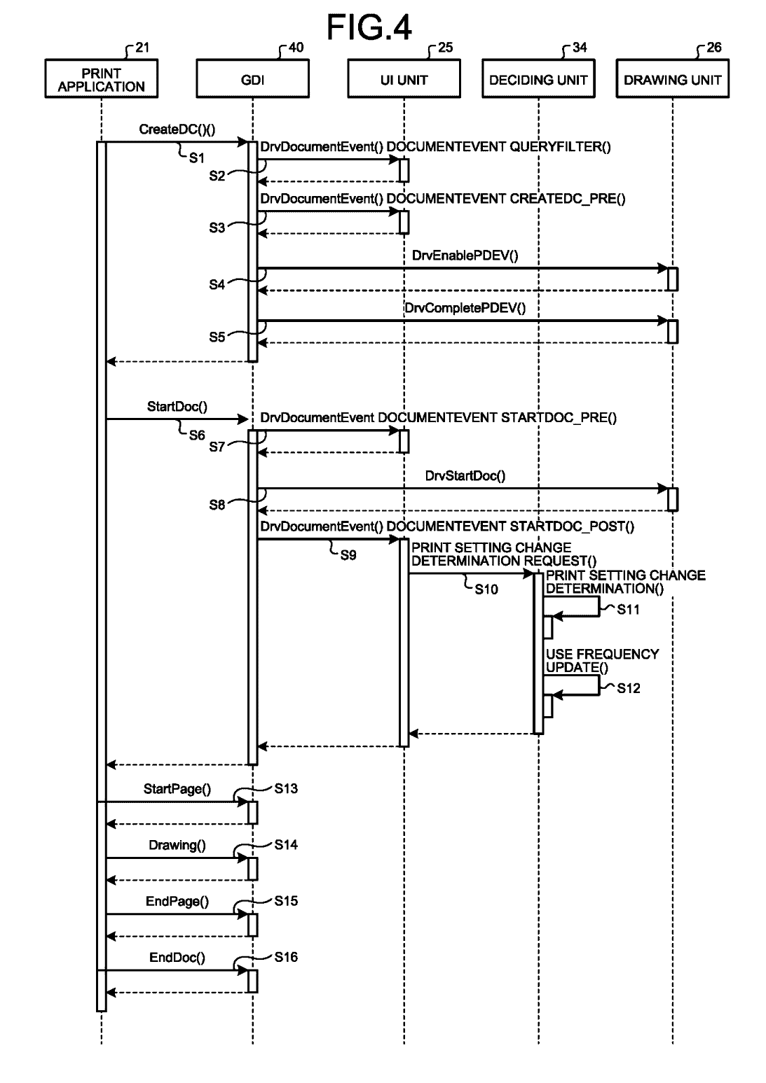

FIG. 4 is a sequence diagram of printing at the PC 1. The PC 1 operates following a process illustrated in the sequence diagram in FIG. 4 by executing the print control program stored in the HDD 14. Specifically, when printing, the print application 21 first acquires device context for drawing through the “CreateDC ( )” method illustrated in step S1. Next, a graphics device interface (GDI) 40 performs the setting of any “DrvDocumentEvent( )” method that the GDI 40 supports. In this example, the GDI 40 supports “DrvDocumentEvent( ) STARTDOC_PRE” and “DrvDocumentEvent( ) STARTDOC_POST” methods (steps S2 to S5).

Next, as illustrated in step S6, the print application 21 specifies printing start through the “StartDoc( )” method. Then, as illustrated in step S7, the GDI 40 calls for (executes) the “DrvDocumentEvent( ) STARTDOC_PRE” method of the UI unit 25. At this timing, the UI unit 25 performs no processing.

Next, as illustrated in step S8, the GDI 40 calls for (executes) the “DrvStarDoc( )” method of the drawing unit 26. At this timing, the drawing unit 26 performs processing necessary for starting printing. Next, as illustrated in step S9, the GDI 40 calls for (executes) the “DrvDocuemntEvent( ) STARTDOC_POST” of the UI unit 25. Then, as illustrated in step S10, the UI unit 25 requests the print setting determination from the deciding unit 34. At step S11, the deciding unit 34 determines whether each print setting has been changed from default values. If the print setting has been changed from the default value, the deciding unit 34 as an exemplary storage control unit, increments the use frequency information 35 of the changed print setting, for example, by one at step S12. In this manner, the number of changes made by each user to the setting options is stored in a storage unit such as the HDD 14.

Next, the print application unit 21 starts printing of the first page through the “StartPage( )” method illustrated in step S13. Then, the print application unit 21 specifies drawing through the “Drawing( )” method illustrated in step S14, specifies the end page through the “EndPage( )” method illustrated in step S15, and specifies the end of a document through the “EndDoc( )” method illustrated in step S16. Lastly, the print application unit 21 releases the device context through “DeleteDC( )”.

In this manner, in the printing system according to the first embodiment, the presence of any change in the print settings is checked every time printing is performed. Then, the printing system according to the first embodiment updates the use frequency information 35 of the print settings, which are changed from the default values, by incrementing the use frequency information 35, for example, by one, and stores the updated use frequency information 35. Accordingly, the use frequency information 35 indicating each user's frequency of use (the number of changes) is stored in the storage unit such as the HDD 14 for each setting option. The frequency of use is different for each user, and thus the storage location of the use frequency information is preferably changeable for each user. Herein, “each user” means a user of each of a plurality of user accounts included in the PC 1. In the printer driver, information on the applications installed by a user is stored at, for example, “HKEY_CURRENT_USER\Software\CompanyName”. Thus, for example, “HKEY_CURRENT_USER” in a registry can be used as the storage location of the use frequency information 35. Alternatively, the storage unit such as the RAM 12, the ROM 13, or the HDD 14 may include storage regions for each user, in which each user's use frequency information 35 is stored.

The use frequency information may be counted in the units exemplarily described below. Specifically, when a setting having a high frequency of use is displayed for each outputting printer used by a user, the use frequency information may be counted for each user and for each icon. When a setting having a high frequency of use is displayed irrespective of the outputting printers of the user, the use frequency information may be counted for each user and for all icons. When a different setting having a high frequency of use is displayed for each outputting printer, the use frequency information may be counted for all users and for each icon. When a setting having a high frequency of use is displayed irrespective of users and printers, the use frequency information may be counted for all users and for all icons.

When the use frequency information is counted in different units in this manner, the storage location of the use frequency information may be changed accordingly. For example, when the use frequency information is counted for each user and each icon, the use frequency information may be stored by dividing the registry of “HKEY_CURRENT_USER” by each icon. When the use frequency information is counted for each user for all icons, the use frequency information may be stored without dividing the registry of “HKEY_CURRENT_USER” by each icon. When the use frequency information is counted for all users and for each icon, the use frequency information may be stored in the separate files for each icon in a location in the PC 1 in use, or a server device or the like in the network, where all users can perform writing. When the use frequency information is counted for all users and all icons, the use frequency information may be stored in a file without separating for each icon in a location in the PC 1 in use, or a server device or the like in the network, where all users can perform writing.

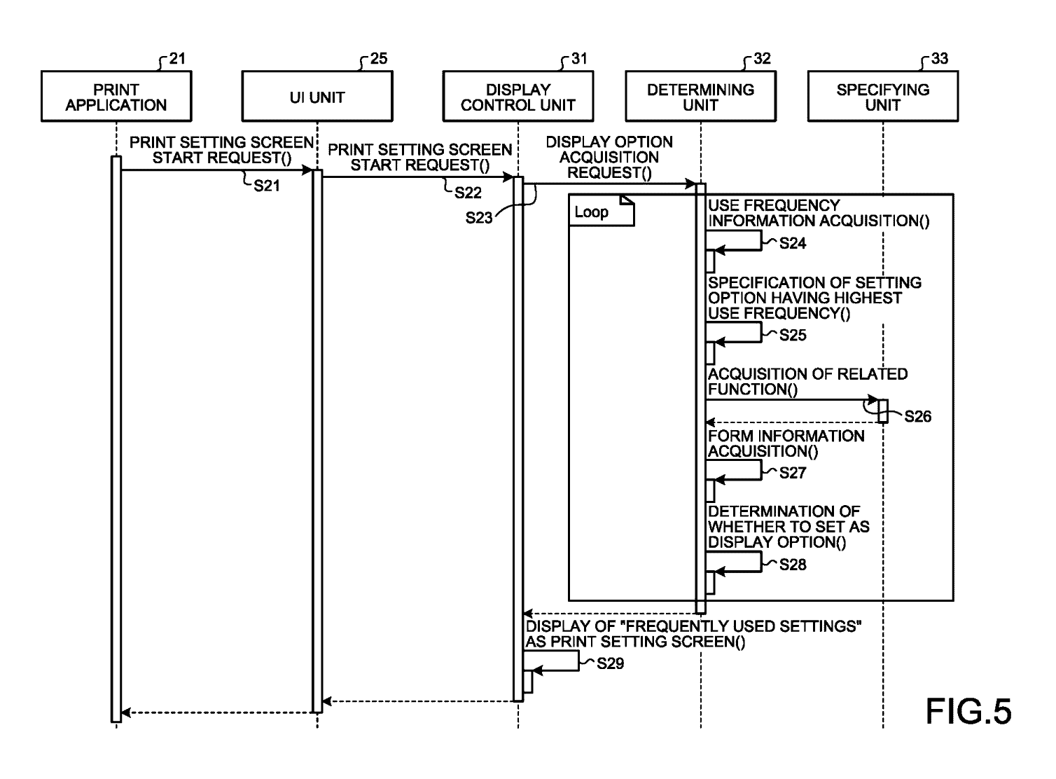

FIG. 5 illustrates a sequence diagram of print settings at the PC 1. The PC 1 operates following a process illustrated in the sequence diagram in FIG. 5 by executing the print control program stored in the HDD 14. Specifically, at print setting, the print application 21 requests the UI unit 25 to start the print setting screen at step S21. The UI unit 25 requests the display control unit 31 to start the print setting screen at step S22. The display control unit 31 requests the determining unit 32 to acquire display options at step S23.

At step S24, the determining unit 32 as an exemplary first acquisition unit acquires the use frequency information 35 of each user, which is stored each time printing is performed as described with reference to the sequence diagram in FIG. 4, from the storage location (storage unit) such as the registry. Specifically, for example, prior to printing or print setting, a user inputs an identification number and a password through the operating unit 18 to log into the PC 1. The CPU 11 individually specifies the user through this login operation. The determining unit 32 acquires the use frequency information 35 of each user from the storage location (storage unit) such as the registry.

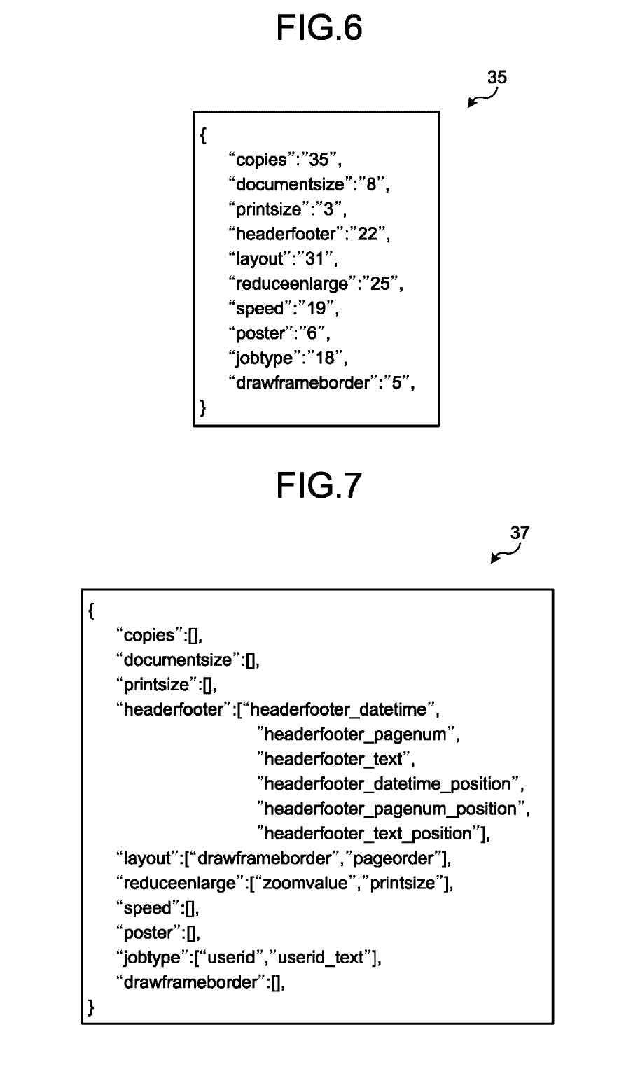

FIG. 6 illustrates exemplary use frequency information 35 written and stored in a description language of the Json (JavaScript (registered trademark) Object Notation) format. In the example in FIG. 6, the number of setting changes made to the printing copies (copies) is 35, and the number of setting changes made to the file size (documentsize) indicating the size of an image is 6. In the example in FIG. 6, the number of setting changes made to the sheet size (printsize) of a sheet on which printing is performed is 3, and the number of setting changes made to the print positions (headerfooter) of a header and a footer is 22. In this example, the use frequency information 35 is written and stored in the description language of the Json format. However, the use frequency information 35 may be written and stored in any other description language.

Next, at step S25 in a sequence diagram in FIG. 5, the determining unit 32 determines the setting option having the highest frequency of use based on the acquired use frequency information 35. In the example in FIG. 6, the number of setting changes made to printing copies (copies) is 35, and this setting option has the highest frequency of use. Thus, the determining unit 32 determines the setting option of printing copies (copies) to be the setting option having the highest frequency of use.

Next, at step S26, the determining unit 32 as an exemplary second acquisition unit queries the specifying unit 33 about the setting options associated with the setting option having the highest frequency of use. The specifying unit 33 specifies the related options associated with the setting option having the highest frequency of use based on the related information 37, and notifies the determining unit 32 of the specified related options. The determining unit 32 determines the notified related options to be the related options of the setting option having the highest frequency of use.

FIG. 7 illustrates exemplary related information 37. In this example in FIG. 7, a setting option (headerfooter_datetime) for setting the header/footer date and time is illustrated as a related option of the setting option of header/footer (headerfooter). A setting option (headerfooter_pagenum) for setting header/footer page numbers is illustrated as another related option of the setting option of header/footer (headerfooter). A setting option (headerfooter_text) for setting a desired header/footer text string is illustrated as another related option of the setting option of header/footer (headerfooter). A setting option (headerfooter_datetime_position) for setting the print position of a date and time is illustrated as another related option of the setting option of header/footer (headerfooter). A setting option (headerfooter_pagenum_position) for setting the print position of a page number is illustrated as another related option of the setting option of header/footer (headerfooter).

In the example in FIG. 1, the setting option (drawframeborder) of whether to print a frame border of each page on one sheet and the setting option of the print position (pageorder) of each page to be printed on one sheet are illustrated as related options associated with the setting option of the layout printing (layout) in which a text body on a plurality of pages is scaled down to fit on one sheet and printed.

Next, at step S21 in the sequence diagram in FIG. 5, the determining unit 32 acquires the form information 36 of the setting option having the highest frequency of use and any related option associated with the setting option having the highest frequency of use. For example, in the printing system according to the first embodiment, the form information 36 is incorporated in the printer driver 22 in advance. Thus, the determining unit 32 acquires the form information 36 from the HDD 14 storing therein the printer driver 22.

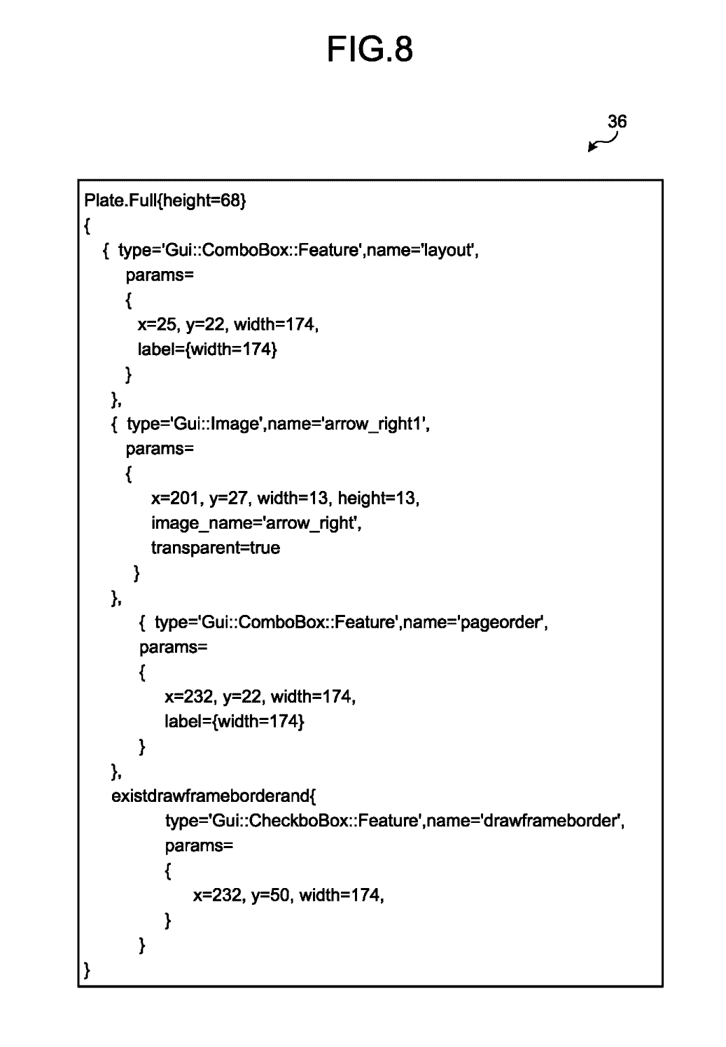

FIG. 8 illustrates exemplary form information 36 of the setting option of “layout (layout)” and a related option thereof. In the printing system according to the first embodiment, the form information 36 on a setting option and related options thereof are stored as one plate in the storage unit such as the HDD 14. As illustrated in FIG. 8, the size of the display region of each setting option is defined to have a maximum height value equal to or smaller than 68 pixels. In the example illustrated in FIG. 8, a combo box (ComboBox) of “layout (layout)” in which a drop-down list or a list box is combined with a text box is defined to be arranged in a region having a width of 174 pixels from the coordinate position of x=25 pixels and y=22 pixels relative to the origin. In the example illustrated in FIG. 8, an icon (arrow_right1) of right arrow is defined to be arranged in a region having a width of 13 pixels and a height of 13 pixels from the coordinate position of x=201 pixels and y=22 pixels. In the example illustrated in FIG. 8, a combo box of “page array (pageorder)” associated with the setting option of “layout (layout)” is defined to be arranged in a region having a width of 174 pixels from a coordinate position of x=232 pixels and y=22 pixels. In the example illustrated in FIG. 8, a check box of “page frame (drawframeborder)” associated with the setting option of “layout (layout)” is defined to be arranged in a region having a width of 174 pixels from the coordinate position of x=232 pixels and y=50 pixels.

In the example illustrated in FIG. 8, the height of the display region of each setting option is maximum 68 pixels, whereas the width is unspecified. This indicates that the width is not restricted, in other words, one plate occupies the entire width of the screen and plates are vertically arranged.

In order to specify the width to horizontally arrange two plates or more, the value of the horizontal width may be written following the height. Alternatively, such a description may be made that two plates are horizontally arranged. Alternatively, instead of being written in the form information, the size (display range) of the plate may be calculated from the size and display position of each display element. For example, for the icon (arrow_right1) of right arrow illustrated in FIG. 8, x=201 pixels and y=27 pixels are written as the display position thereof in the plate. It is also written that the icon (arrow_right1) of right arrow is displayed in the width of 13 pixels and the height of 13 pixels. In this manner, the size (display range) of the plate may be calculated from the display position and size of a display element.

A default height is set In advance for display elements having no height (height) specification in the form information, such as the layout (layout), the page order (pageorder), or the icon (arrow_right1) of right arrow illustrated in FIG. 8. Then, the default height may be applied to the display elements having no height (height) specification in the form information.

Next, at step S28 in the sequence diagram in FIG. 5, the determining unit 32 determines whether a display region for displaying a setting option having the highest frequency of use and related options thereof exists on the print setting screen. Specifically, the determining unit 32 performs the determination at step S28 based on the specification of sizes (the display range, and the height and width of a plate) included in the above-described form information 36, or a result of calculation of these sizes (display range). Specifically, the determining unit 32 stores therein the height and width of the entire print setting screen in advance. Then, the determining unit 32 compares the width and height of the plate (options (functions) associated with the setting option) subject to the determination of whether to make it a display option, with the arrangement positions of each plate, which have been determined to be the display options, on the print setting screen and the height and width of the entire print setting screen, so as to determine whether the display region which can be arranged in the print setting screen is present.

As described with reference to the example in FIG. 8, when all plates have no width specification, the determining unit 32 compares the value obtained by adding the height of the plate subject to the determination to the sum of the heights of each plate determined to be the display options, with the height of the entire print setting screen which is stored in advance. Then, if the value of the height of the entire print setting screen is larger, the determining unit 32 determines that a display region is available on the print setting screen.

If a display region is available for each setting option, the determining unit 32 returns the process back to step S24 to detect a setting option having the second highest frequency of use and a related option thereof. The determining unit 32 repeats the operation of detecting a setting option and related options thereof in descending order of the frequency of use in this manner, until it is determined at step S28 that no display region is available on the print setting screen. In other words, the determining unit 32 determines whether to display a setting option and related options thereof on the display unit 17 based on “the frequency of use of the setting options”, “the availability of the related options”, and “the form information on the setting option and the related options thereof”.

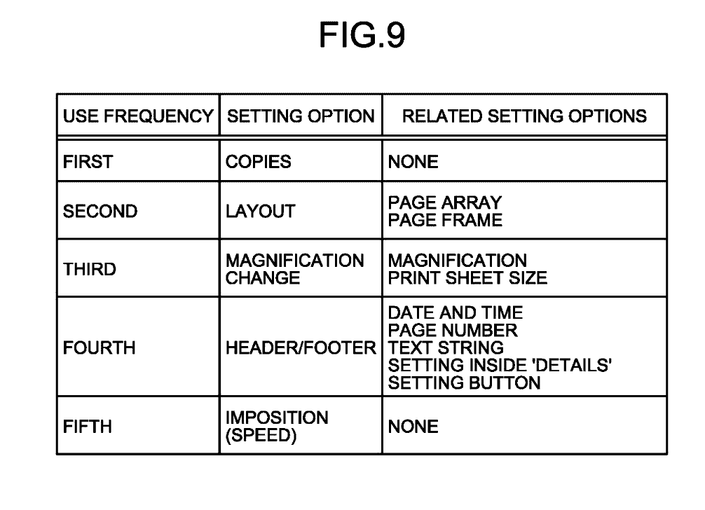

FIG. 9 illustrates exemplary setting options and related options thereof in descending order of the frequency of use. In a case of a user in this example, setting options have higher frequencies of changes (higher frequencies of use) in the order of “copies”, “layout”, “magnification change”, “header/footer”, and “imposition (speed)”. The setting option of “copies” is a setting option for specifying the number of copies to be printed. The setting option of “layout” is a setting option for specifying a plurality of pages to be printed on one sheet. The setting option of “magnification change” is a setting option for specifying a print size. The setting option of “header/footer” is a setting option for specifying whether to print the header or the footer. The setting option of “imposition (speed)” is a setting option for selecting one setting (speed setting) from a plurality of kinds of imposition settings for printing a plurality of pages on one sheet.

In the case of the user in the example in FIG. 9, the setting options associated with the setting option of “copies” are “none”. The value “none” indicates that no associated setting options are in present. The setting options associated with the setting option of “layout” are the setting options of “page array” and “page frame”. The setting option of “page array” is a setting option for setting an array of a plurality of pages to be printed on one sheet. The setting option of “page frame” is a setting option for setting whether to print a frame border on each of a plurality of pages printed on one sheet.

The setting options associated with the setting option of “magnification change” are the setting options of “magnification” and “print sheet size”. The setting option of “magnification” is a setting option for setting the rate of expansion or reduction of a print. The setting option of “print sheet size” is a setting option for setting the size of a sheet used in printing. The setting options associated with the setting option of “header/footer” are the setting options of “date and time”, “page number”, “text string”, and “setting inside ‘details’ setting button”. The setting options associated with the setting option of “imposition (speed)” is “none”.

Next, in the sequence diagram in FIG. 5, if it is determined that no display region is available on the print setting screen, the process proceeds to step S29. At step S29, the display control unit 31 as an exemplary display control unit displays a predetermined number of setting options and related options thereof on the print setting screen in descending order of the frequency of use. The “predetermined number” of setting options and related options thereof to be displayed is the number thereof displayable on the print setting screen based on the above- described form information 36. Accordingly, one or a plurality of setting options and related options more frequently used by a user are displayed on the display unit 17 as the print setting screen titled, for example, “frequently used setting option”.

FIG. 10 illustrates an exemplary print setting screen of “frequently used setting options”. In the example illustrated in FIG. 10, the setting options of “copies”, “layout”, “magnification change”, “header/footer”, and “imposition (speed)” are displayed from the upper part of the print setting screen to the lower part thereof in descending order of the frequency of use. In the example illustrated in FIG. 10, no related option of the setting option of “copies” is displayed (“none” in the above description), and the setting options of “page array” and “page frame” are displayed as related options of the setting option of “layout”. In the example illustrated in FIG. 10, the setting options of “magnification” and “print sheet size” are displayed as related options of the setting option of “magnification change”. The setting options of “date and time”, “page number”, “text string”, and “setting inside ‘details’ setting button” are displayed as related options of the setting option of “header/footer”. No related option of the setting option of “imposition (speed)” is displayed (“none” in the above description).

In FIG. 10, as described with reference to FIG. 8, the combo box SC of “layout (layout)” is displayed in a region having a width of 174 pixels from a coordinate position of x=25 pixels and y=22 pixels. The icon AR of right arrow is displayed in a region having a width and a height of 13 pixels from a coordinate position of x=201 pixels and y=22 pixels. The combo box PC of “page array (pageorder)” is displayed in a region having a width of 174 pixels from a coordinate position of x=232 pixels and y=22 pixels. The check box CB of “page frame (drawframeborder)” is displayed in a region having a width of 174 pixels from a coordinate position of x=232 pixels and y=50 pixels.

As described above, in the printing system according to the first embodiment, setting options having high frequencies of use are stored for each user in advance, and when the print setting screen is displayed, a list of setting options having high frequencies of use is displayed corresponding to the current user. Accordingly, the setting options to be actually used by the current user can be displayed. This allows as much reduction as possible in the operations of changing setting options, thereby providing a printing system having improved operability and usability.

In the printing system according to the first embodiment, in addition to the setting options more frequently used by each user, the setting options associated with each setting option are also displayed on the print setting screen. This can eliminate the necessity for, for example, cumbersome operations of, after setting a setting option having a high frequency of use, searching for setting options related thereto before performing setting, thereby providing a printing system having further improved operability and usability.

### Second Embodiment

The following describes a printing system according to a second embodiment of the present invention. For example, after setting options are changed through an individual option setting screen such as a printer property, an operation to change a setting option on the above-described print setting screen (print setting screen of frequently used settings), which is a list of setting options having high frequencies of use, can be prohibited because the setting option to be changed has an exclusive relation with other setting options. In this case, it is difficult to detect the setting options that have the exclusive relation on the print setting screen of the setting options having high frequencies of use. Thus, a user needs to identify the setting options having the exclusive relation again on the individual option setting screen such as a printer property so as to eliminate the exclusive relation. This will degrade the operability and usability of the printing system.

The printing system according to the second embodiment further improves the operability and usability of the printing system, when the settings of the setting options (exclusive options) in exclusive relation affect the operations to change the setting options to be changed, by displaying the indication that exclusive options exist for the setting options to be changed, and by allowing the change in the exclusive options. The second embodiment differs from the above-described first, embodiment in that the display of exclusive options is available and the setting of exclusive options can be changed. Thus, in the following, the difference between the embodiments will only be described, and any duplicate description will be omitted.

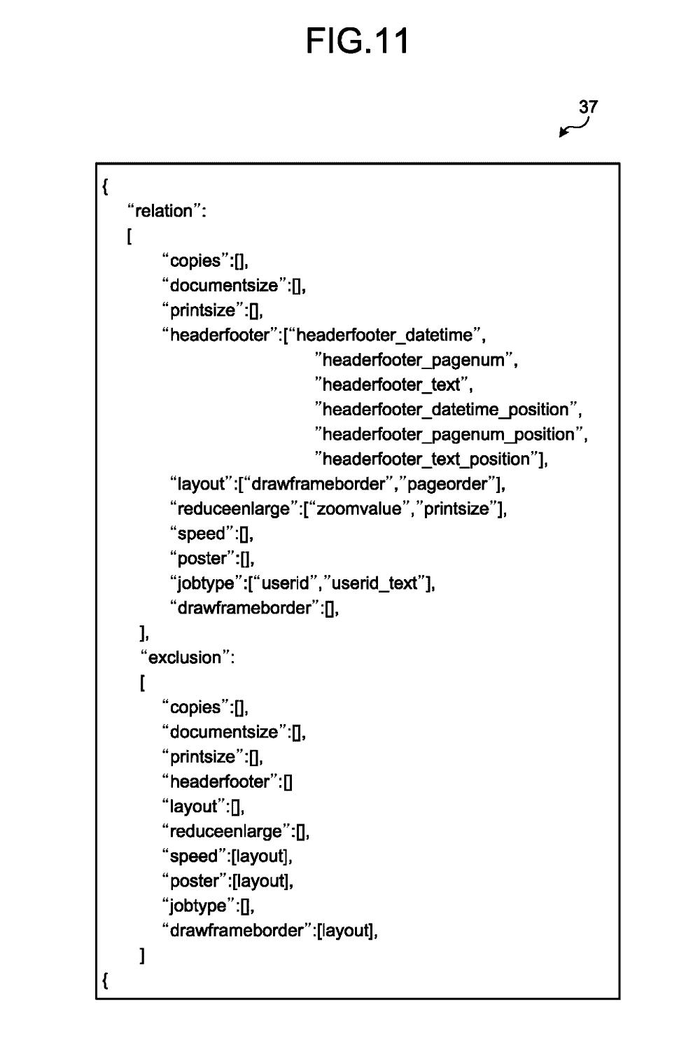

In the printing system according to the second embodiment, as illustrated in FIG. 11, setting options, related setting options, and exclusive options are stored as the above-described plate in the storage unit such as the HDD 14. The statement below “relation” illustrated in FIG. 11 describes each setting option and related options thereof. In the example in FIG. 11, for example, there is no related options associated with the number of copies (copies). The related options associated with the setting option of layout printing (layout) are the setting option of whether to print the frame border of each page printed on one sheet (drawframeborder) and a setting option of the print position (pageorder) of each page printed on one sheet.

The statement below “exclusion” illustrated in FIG. 11 describes exclusive options in an exclusive relation with each setting option. In the example in FIG. 11, no exclusive option has an exclusive relation with the setting option of the number of copies (copies). The setting, option of the layout printing (layout) is illustrated as an exclusive option having an exclusive relation with the imposition (speed). The setting option of the layout printing (layout) is illustrated as an exclusive option having an exclusive relation with the setting option of whether to print the frame border of each page printed on one sheet (drawframeborder).

At step S26 in the sequence diagram in FIG. 5, the determining unit 32 acquires setting options, related options, and exclusive options of a plate as illustrated in FIG. 11 from the storage unit such as the HDD 14. When the setting context of the exclusive option affects an operation to change a setting option to be changed, the determining unit 32 detects, from the storage unit such as the HDD 14, exclusive options having an exclusive relation with the setting option to be changed.

The storage unit such as the HDD 14 stores therein, as the above-described form information 36, information indicating the width, height, and display position of the combined display of setting options, related options, and exclusive options. The determining unit 32 determines setting options and the like to be displayed on the display unit 17 based on “the frequency of use of setting options”, “the presence of related options”, “the form information on the setting options and related options thereof”, and “the presence of exclusive options”. At above-described step S29, the display control unit 31 displays a display option and the like determined to be displayed, in the size and position indicated by the form information 36.

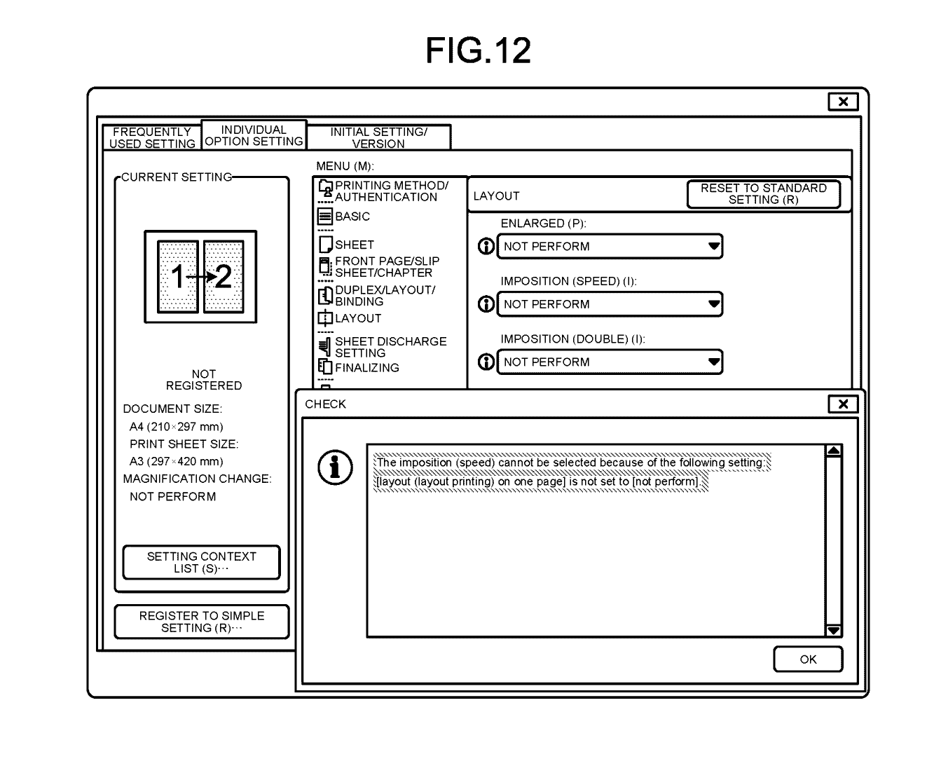

FIG. 12 illustrates exemplary display of an exclusive option. In the example illustrated in FIG. 12, the setting option of layout printing (layout) is set to be “perform”through the individual option setting screen such as a printer property, and then an operation to change the setting option of imposition (speed) is specified from the above-described list of setting options having high frequencies of use. The setting of layout printing (layout) is a setting for printing a plurality of pages on one sheet. Similarly, the setting of Imposition (speed) is a setting for printing a plurality of pages on one sheet with a difference in the printing format. Thus, the setting option of layout printing (layout) is in an exclusive relation with the setting option of imposition (speed). Accordingly, when the setting option of layout printing (layout) is set to “perform”, the setting option of imposition (speed) cannot be set as it is a setting option of the same kind.

In this case, as illustrated in FIG. 12 for example, the determining unit 32 performs display indicating an exclusive option in an exclusive relation by displaying a message such as “The imposition (speed) cannot be selected because of the following setting: [layout (layout printing) on one page] is not set to [not perform].” This allows a user to recognize that the setting of imposition (speed) to be changed cannot be performed because of the setting of the layout printing set in the past. The display of a specified exclusive option allows the user to quickly recognize the setting option causing the problem. This eliminates a necessity for an operation to detect exclusive options or the individual option setting screen such as a printer property so as to eliminate the exclusive relation, thereby achieving further improvement in the operability and usability of the printing system, and obtaining the same effect as that of the above-described first embodiment.

Similarly to the above-described related options, an exclusive option can be changed by a user. Specifically, when an exclusive option is selected by the user, the determining unit 32 displays, for example, a pull-down menu of the selected exclusive option. The determining unit 32 sets a desired exclusive option selected by the user from the pull-down menu, and automatically changes a setting option corresponding to the set exclusive option so as to activate the set exclusive option. In other words, in the example in FIG. 12, when the user selects the setting option of “imposition (speed)” as an exclusive option of the setting option of “layout (layout printing)”, the determining unit 32 automatically changes the setting option of “layout (layout printing)” to “not perform”. In this manner, when an exclusive setting is changed, the corresponding setting option can be changed so as to activate the changed exclusive setting.

The determining unit 32 may display any option activated in accordance with the current setting options and let the user select therefrom. For example, the setting for punching a hole in a central part of a sheet is an exclusive relation with the setting for stapling in the central part of the sheet. However, the setting for punching a hole in the central part of the sheet is possible if it is with the setting for stapling on the right edge or the left edge of the sheet. Thus, when the setting for punching a hole in the central part of the sheet is performed, the determining unit 32 displays a pull-down menu for selecting the setting for stapling in the right edge of the sheet or the left edge of the sheet. Then, the determining unit 32 performs the setting corresponding to an option selected by the user from the pull-down menu. This allows the setting of effective and desired exclusive option.

### Third Embodiment

The following describes a printing system according to a third embodiment. The printing system according to the above-described first embodiment displays settings on the print setting screen in descending order of the frequency of use. The printing system according to the third embodiment displays settings of similar functions (settings of functions categorized in an identical category) in close proximity to each other on the print setting screen. The third embodiment differs from the above-described embodiments only in this point. Thus, the following only describes the difference, and any duplicate description will be omitted.

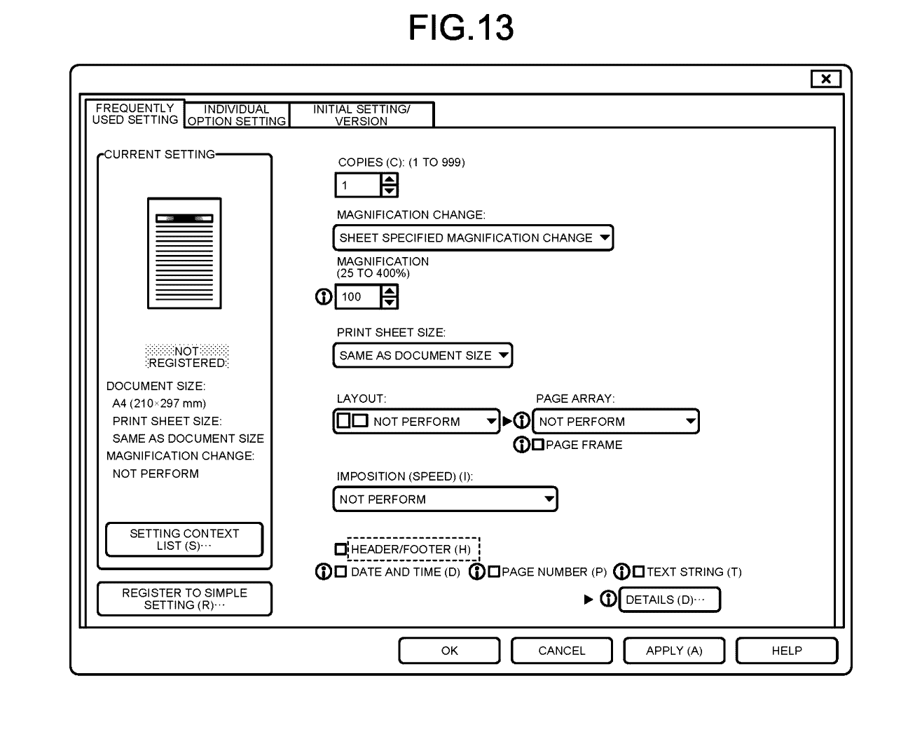

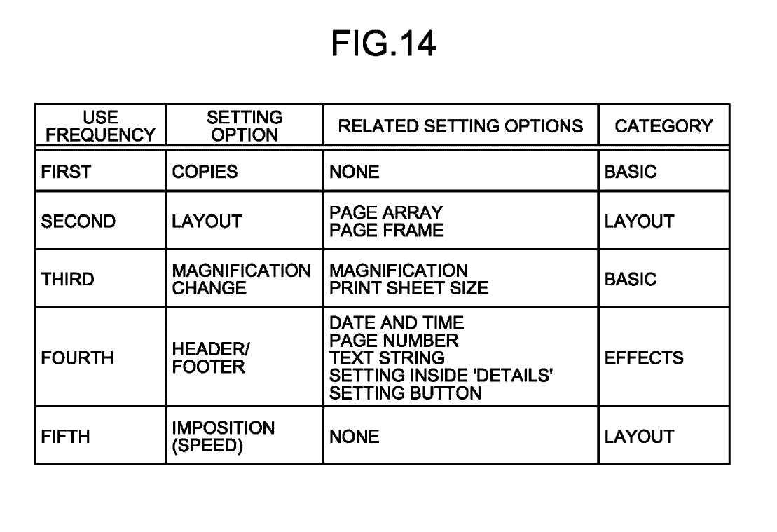

FIG. 13 illustrates an exemplary print setting screen displaying settings of functions categorized in an identical category in close proximity to each other. FIG. 14 is a diagram illustrating a list of the functions categorized in the identical category. As illustrated in FIG. 14, the setting of copies having the highest frequency of use arid the setting of magnification change having the third highest frequency of use are categorized in the category of “Basic”. Thus, as illustrated in FIG. 13, the determining unit 32 determines to display the setting option of magnification change on the print setting screen at a position close to the setting option of copies. Similarly, as illustrated in FIG. 14, the setting of layout having the second highest frequency of use and the setting of imposition (speed) having the fifth highest frequency of use are categorized in the category of “Layout”. Thus, as illustrated in FIG. 13, the determining unit 32 determines to display the setting option of imposition (speed) on the print, setting screen at a position close to the setting option of layout. The display control unit 31 displays each setting option on the print setting screen in a display order determined by the determining unit 32.

In other words, the determining unit 32 determines to display a setting option having the first highest frequency of use at a highest position on the print setting screen, and display the setting option in the category identical to that of the setting option having the first highest frequency of use, at a position following the setting option having the first highest frequency of use. When there are a plurality of setting options in the identical category, the determining unit 32 determines to arrange and display each setting option In the identical category in descending order of the frequency of use. Next, the determining unit 32 determines to display the setting option (the next highest setting option) having the highest frequency of use in the setting options not displayed, at a position following a setting option displayed at the last among the arranged and displayed setting options in the identical category. The determining unit 32 also determines to display a setting option in the category identical to that of the next highest setting option, at a position following the next highest setting option. When there are a plurality of setting options in the identical category, the determining unit 32 determines to arrange and display each setting option in the identical category in descending order of the frequency of use. The display control unit 31 displays each setting option on the print setting screen based on the frequencies of use and the categories determined in this manner.

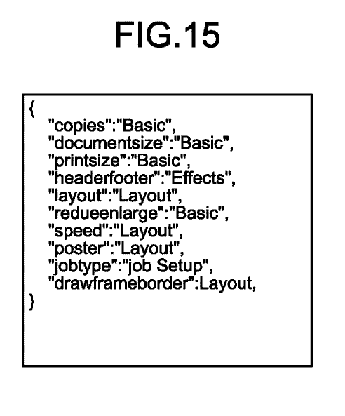

FIG. 15 illustrates exemplary categorizing information indicating the category of each setting option. This categorizing information is stored in, for example, the storage unit such as the HDD 14. In the example in FIG. 15, the number of copies (copies), document sheet size (documentsize), and magnification change (reduceenlarge) are categorized in a category called “Basic”. In the example In FIG. 15, the setting of header footer (headerfooter) is categorized in a category called “Effects”.

In the example in FIG. 15, the settings of “layout”, “speed”, “poster”, and whether to print a frame border (“drawframeborder”) are categorized in a category called “Layout”. In the example in FIG. 15, the setting of a printing method (Jobtype) is categorized in a category called “Job Setup”.

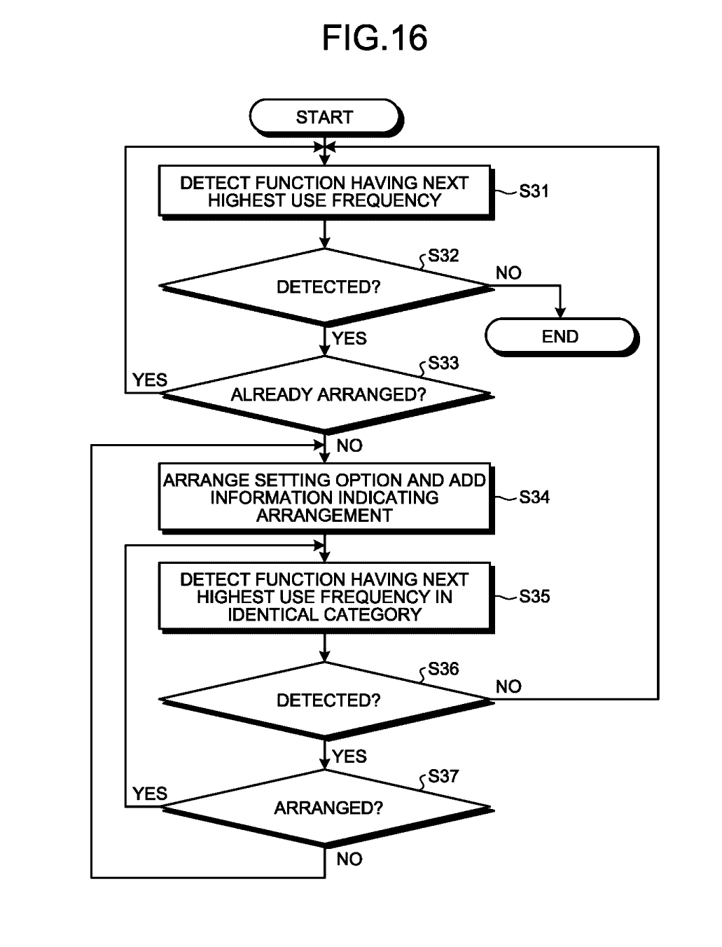

Next, FIG. 16 is a flowchart of an operation performed by the determining unit 32 to determine a display order of each setting option based on the frequency of use and category thereof. As illustrated in this flowchart, first at step S31, the determining unit 32 detects a setting option having the highest frequency of use among functions (setting options) currently not displayed on the print setting screen. Next at step S32, the determining unit 32 determines whether a setting option having the highest frequency of use is detected. If it is determined that no setting option having the highest frequency of use is detected (No at step S2), this indicates that the processing of determining the display order is completed for all setting options. Thus, the determining unit 32 ends all processing of the flowchart in FIG. 16.

If it is determined that a setting option having the highest frequency of use is detected (Yes at step S32), the determining unit 32 proceeds the process to step S33. At step S33, the determining unit 32 determines whether the detected setting option having the highest frequency of use is already arranged (displayed) on the print setting screen, by referring to an arrangement information storage unit to be described later. If it is determined that the detected setting option is already arranged on the print setting screen (Yes at step S33), the determining unit 32 returns the process to step S31 to detect a setting option having the next highest frequency of use.

If it is determined that the detected setting option is already arranged on the print setting screen (No at step S33), the determining unit 32 proceeds the process to step S34 to determine an arrangement position on the print setting screen at which the setting option detected at step S31 is to be arranged. For example, the storage unit such as the HDD 14 includes the arrangement information storage unit storing therein the arrangement information indicating whether each setting option has been arranged on the print setting screen. The determining unit 32 stores the arrangement information on the setting options already arranged on the print setting screen in the arrangement information storage unit. At step S33 described above, the determining unit 32 determines whether the setting option detected at step S31 has been arranged by searching the arrangement information storage unit for the arrangement information corresponding to the setting option detected at step S31.

Next at step S35, the determining unit 32 detects a function categorized in the category identical to that of the setting option detected at step S31 and having the next height frequency of use (having the second highest frequency of use). Then, at step S36, the determining unit 32 determines whether a setting option having the second highest frequency of use is detected. If it is determined that a setting option having the second highest frequency of use is not detected (No at step S36), the determining unit 32 returns the process to step S31 to detect a setting option having the highest frequency of use other than the setting options that has been ever detected.

If a setting option having the second highest frequency of use is detected, at step S37, the determining unit 32 determines whether the setting option having the second highest frequency of use is already arranged on the print setting screen by referring to the above-described arrangement information storage unit. If the setting option is not already arranged on the print, setting screen (No at step S37), the determining unit 32 returns the process to step S34 to determine the arrangement position of the setting option having the second highest frequency of use on the print setting screen, and stores arrangement information indicating that the setting option is already arranged, in the above-described arrangement information storage unit.

If the setting option is already arranged on the print setting screen (Yes at step S37), the determining unit 32 returns the process to step S35 to detect a setting option categorized in a category identical to that of the setting option detected at step S31 and having the third highest frequency of use.

The determining unit 32 detects setting options In an identical category in descending order of the frequency of use in this manner, and determines arrangement positions so that setting options in the identical category are displayed in close proximity to each other on the print setting screen. The display control unit 31 displays the setting options at the arrangement positions on the print setting screen determined by the determining unit 32.

As described above, the printing system according to the third embodiment arranges and displays setting options categorized in an identical category on the print setting screen in descending order of the frequency of use. This allows categorization of arrangements of setting options having high frequencies of use for each category, thereby providing the user with a print setting screen easier to use and achieving the same effect as those of the above- described embodiments.

### Fourth Embodiment

The following describes a printing system according to a fourth embodiment. In some cases, a user intentionally sets an exclusive relation between setting options. In addition, a setting option affected by an exclusive relation does not really need to be displayed even if it has a high frequency of use. For this reason, in the printing system according to the fourth embodiment, any setting option affected by the exclusive relation is not displayed on the print setting screen when print setting is performed. The fourth embodiment differs from the above-described embodiments in this point. Thus, the following describes only the difference, and any duplicate description will be omitted.

Specifically, at step S25 in the sequence diagram illustrated in FIG. 5, having specified a setting option having a high frequency of use, the determining unit 32 determines whether the specified setting option is affected by exclusion. If the specified setting option is affected by exclusion, the determining unit 32 excludes this setting option from a display target on the print setting screen. Then, the determining unit 32 specifies another setting option having a high frequency of use again at step S25. In this manner, when a setting option is affected by exclusion, the determining unit 32 repeats the operation to specify another setting option until it detects a setting option not affected by exclusion.

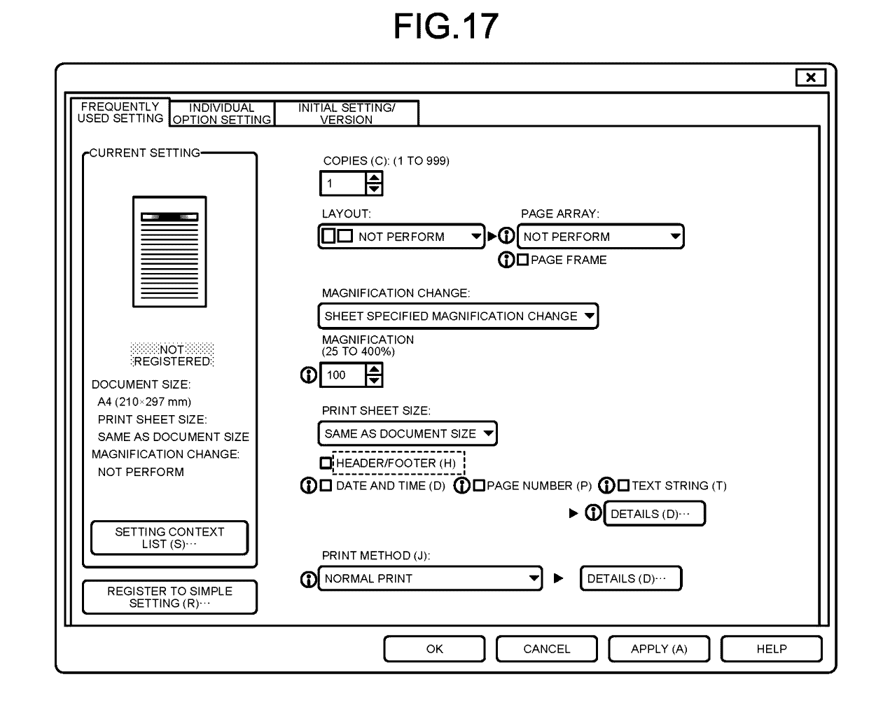

FIG. 17 illustrates an exemplary print setting screen not displaying setting options affected by exclusion. The setting option of “imposition (speed)” has the fifth highest frequency of use as illustrated in FIG. 14. However, the setting option of “imposition (speed)” is affected by exclusion and not displayed because the setting option of “magnification change” is set to “sheet specified magnification change”. Accordingly, the determining unit 32 determines to display, in place of the setting option of “imposition (speed)”, the setting option of “printing method” having the sixth highest frequency of use, and the display control unit 31 displays the print setting screen.

As is clear from the description above, the printing system according to the fourth embodiment does not display a setting option in an exclusive relation even when this setting option has a high frequency of use, thereby prioritizing display of a setting option desired by the user or a setting option highly likely to be used on the print setting screen. This can provide the user with a print setting screen easier to use, thereby achieving the same effect as those of the above-described embodiments.

Exemplary embodiments of the present invention can improve the operability and usability of a device.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A non-transitory computer-readable recording medium that contains a print control program executed by a computer configured to transmit a print instruction to an image processing device through a network, the print control program being configured to cause the computer to function as:
a storage control unit configured to store, in a storage unit, the number of changes made on a print setting option through the print control program;
a determining unit configured to determine a setting option to be displayed based on the number of changes and determine a related option of the determined setting option to be a related option to be displayed; and
a display control unit configured to display the determined setting option and the determined related option on a display unit

2. The non-transitory computer-readable recording medium according to claim 1, wherein
the storage unit stores therein, for each setting option, an exclusive option that Is a setting option prohibited from being set depending on a setting context of a setting option,
the determining unit determines the related option and the exclusive option, and
the display control unit displays the determined setting option, the determined related option, and the determined exclusive option on the display unit.

3. The non-transitory computer-readable recording medium according to claim 1, wherein
the storage unit stores therein form information indicating the size and position of display of at least the setting option and the related option, and
the display control unit displays at least the setting option and the related option on the display unit in accordance with the form information.

4. The non-transitory computer-readable recording medium according to claim 1, wherein
the display control unit determines whether to display the setting option and the related option on the display unit based on “the number of changes made on the setting option”, “availability of the related option”, and “form information on the setting option and the related option”.

5. The non-transitory computer-readable recording medium according to claim 1, wherein
the storage control unit stores, in the storage unit for each user, the number of changes made on a print, setting option through the print control program, and
the determining unit determines the setting option and the related option corresponding to the user based on the number of changes.

6. The non-transitory computer-readable recording medium according to claim 1, wherein
the determining unit determines setting options and a display order so that the setting options categorized in an identical category are displayed close to each other in descending order of frequency of use, and
the display control unit displays the determined setting options on the display unit in the determined display order. 7. The non-transitory computer-readable recording medium according to claim 2, wherein
the determining unit determines not to display the exclusive option, and
the display control unit does not display the determined exclusive option on the display unit.

8. An information processing device configured to transmit a print instruction to an image processing device through a network, the information processing device comprising:
a storage control unit configured to store, in a storage unit, the number of changes made on a print setting option through the information processing device;
a determining unit configured to determine a setting option to be displayed based on the number of changes, and determine a related option of the determined setting option to be a related option to be displayed; and
a display control unit configured to display the determined setting option and the determined related option on a display unit, 9. The information processing device according to claim 8, wherein
the storage unit stores therein, for each setting option, an exclusive option that is a setting option prohibited from being set depending on a setting context of the setting option,
the determining unit determines the related option and the exclusive option, and
the display control unit displays the determined setting option, the determined related option, and the determined exclusive option on the display unit.

10. The Information processing device according to claim 8, wherein
the storage unit stores therein form information indicating the size and position of display of at least the setting option and the related option, and
the display control unit displays at least the setting option and the related option on the display unit in accordance with the form information. 11. The information processing device according to claim 8, wherein
the display control unit determines whether to display the setting option and the related option on the display unit based on “the number of changes made on the setting option”, “availability of the related option”, and “form information on the setting option and the related option”.

12. The information processing device according to claim 8, wherein
the determining unit determines setting options and a display order so that the setting options categorized in an identical category are displayed close to each other in descending order of frequency of use, and
the display control unit displays the determined setting options on the display unit in the determined display order.

13. The information processing device according to claim 9, wherein
the determining unit determines not to display the exclusive option, and
the display control unit does not display the determined exclusive option on the display unit.

14. An information processing system comprising:
an image processing device configured to perform image processing; and
an information processing device configured to transmit a print instruction to the image processing device through a network,
the information processing device including:
a storage control unit configured to store, in a storage unit, the number of changes made on a print setting option through the information processing device,
a determining unit configured to determine a setting option to be displayed based on the number of changes, and determine a related option of the determined setting option to be a related option to be displayed, and
a display control unit configured to display the determined setting option and the determined related option on a display unit.
